(19) United States
(12) Patent Application Publication
(10) Pub. No.: US 2015/0233063 A1
(43) Pub. Date: Aug. 20, 2015

(54) TAMPING TOOL

(71) Applicant: John Klippel, Arena, WI (US)

(72) Inventor: John Klippel, Arena, WI (US)

(21) Appl. No.: 14/498,381

(22) Filed: Sep. 26, 2014

Related U.S. Application Data
(60) Provisional application No. 61/941,320, filed on Feb. 18, 2014.

(51) Int. Cl. E01B 27/20; B23K 1/00; E01B 1/00

(52) U.S. Cl. CPC E01B 27/20; E01B 1/001; B23K 1/0008

(57) ABSTRACT

A tamping tool for tamping ballast in place is disclosed. In a preferred embodiment, the tamping tool comprises a shank and a paddle. The paddle has an upper and lower portion; the upper portion has a plurality of apertures and the lower portion is coupled to a paddle. The paddle has a first face, a second face, and a tip. A first shoulder is disposed in the first face and defines a recess leading to the tip of the paddle. The paddle also has a plurality of first wear tiles. The plurality of first wear tiles each has an upper portion terminating in an upper edge and a lower portion that defines a ridge and which tapers into a rounded tip. The plurality of first wear tiles are at least partially provided in the recess such that the upper edge of each first wear tile at least partially abuts the first shoulder, the ridge defined in each first wear tile partially abuts the tip of the paddle, and the lower portion of each wear tile wraps substantially around the tip.

### CLAIM OF PRIORITY

This application claims priority to U.S. Provisional Application 61/941,320, filed Feb. 18, 2014, which is incorporated herein by reference in its entirety.

### TECHNICAL FIELD

The present invention relates to the field of tamping machines and tools. The present invention more specifically relates to the field of tamping tools for adjusting and leveling ballast under railroad ties and tracks.

### BACKGROUND

Railroad tracks are typically supported by ties, which rest upon ballast. Ballast is typically comprised of crushed stone, rocks, or gravel. The ballast is packed below and around the railroad ties to, among other things, bear the load from the railroad ties, facilitate water drainage, and hold the track in place. Over time, the ballast can shift or otherwise move out of place from its position packed around and below the railroad ties. Ballast tamping machines, which often run along the track, are used to move and/or tamp ballast back into place to keep the ties and track adequately supported by the ballast.

Ballast tamping machines utilize replaceable tamping tools that compress the ballast. These tools repeatedly make contact with the ballast as they are moved along the track. As a result, the tamping tools undergo a great deal of wear from the impact. Known tamping tools frequently break down, come apart, or wear quickly as a result of the impact with the ballast and need to be replaced.

In some cases, the tamping tool will include wear-resistant materials provided on top of the tool to help extend the life to the tool but, even then, the wear-resistant materials will often fall off due to the impact with ballast and contact with other components of the railroad system. For example, U.S. Pat. Nos. 7,726,246 and 5,261,763 disclose ballast-tamping tools with abrasion or wear-resistant material provided on the face of the blade of the tool, however, the material tends to break off as the tool is used, causing the tool in turn to break and require replacement.

Therefore, a tamping tool that resists wear and withstands the impact without requiring frequent replacement is needed.

### SUMMARY

Accordingly, a tamping tool which overcomes this and other difficulties is provided. The tool is provided in two parts: a shank and a paddle. In an exemplary embodiment, the shank and paddle are constructed of an impact-resistant material such as iron, steel, or an alloy such as a carbon-based alloy. The steel may be forged and/or heat-treated to improve the hardness, strength, and/or life of the material.

In an exemplary embodiment of the present invention, the shank has a number of apertures which allows the tool to be connected to a ballast tamping machine. The top of the shank has four sides, connected to the bottom of the shank, which tapers in towards the paddle and may have six sides. The shank attaches to the paddle on the opposite end of the shank from the apertures.

In one embodiment, the paddle is integrally formed with the shank. In other embodiments, the blade is coupled to the shank in other ways, for example by welding. In an exemplary embodiment of the tool, on the base of the shank, where the shank couples to the paddle, a set of wear-resistant tiles (or “wear tiles”) is provided. The wear tiles may be constructed of various wear-resistant materials, for example tungsten carbide. The wear tile will typically be brazed onto the paddle or shank using methods and materials disclosed further herein.

The paddle may have six faces—a front, back, tip, left, right, and top sides. In one or more embodiments, the paddle couples to the shank on the front side. In an exemplary embodiment, the front side of the paddle has a first ridge defining a recess that leads to the tip of the paddle. A row of wear tiles are provided in the recess.

On the back of the paddle, a series of row tiles is also provided into a groove. These row tiles are shaped so that the wear tile hooks around the tip of the paddle. The front set of wear tiles fits within the lip provided by the back hook-like wear tiles.

The paddle may have more shoulders or grooves, and more rows of wear tiles. For example, a second shoulder or groove on the front of the paddle may have further wear tiles adapted to fit within the shoulder or groove. In an exemplary embodiment of the invention, three rows are provided on the front of the tool and two rows of larger wear tiles are provided on the back of the tool, with one of the rows provided on the back wrapping around to the front. Wear tiles in that configuration are not provided on the left, right, or top sides of the paddle.

Although it is known in the art to provide a wear-resistant material on the outside of a tool, the present configuration has lead to decreased damage, increased shock absorption, and improved overall durability over known tamping-tool configurations. Wear tiles stay on the tool much longer over known tamping tools, leading to preservation of the paddle, and decreased replacement frequency.

The present disclosure provides a tamping tool comprising: a shank having an upper and lower portion, the upper portion having a plurality of apertures and the lower portion being coupled to a paddle; the paddle comprising: a first face, a second face, and a tip; a first shoulder disposed in the first face and defining a recess leading to the tip of the paddle; a plurality of first wear tiles each having an upper portion terminating in an upper edge and a lower portion that defines a ridge and which tapers into a rounded tip; the plurality of first wear tiles being at least partially provided in the recess such that the upper edge of each first wear tile at least partially abuts the first shoulder, the ridge defined in each first wear tile at partially abuts the tip of the paddle, and the lower portion of each wear tile wraps substantially around the tip.

The present disclosure further provides a tamping tool, comprising a shank and a paddle: the shank having an upper and lower portion, the upper portion being configured to couple to a tamping machine and the lower portion being coupled to the paddle; a plurality of wear tiles coupled to the lower portion of the shank; the paddle having a first face, second face, and tip; the first and second face having a plurality of wear tiles provided thereon; the first face having a first ridge and second ridge; the plurality of wear tiles including a plurality of first wear tiles, each having an upper portion terminating in an upper edge and a lower portion that defines a ridge and which tapers into a rounded tip; the plurality of first wear tiles configured such that the first wear tiles abut the ridge provided on the paddle and extend around the paddle tip.

The present disclosure further provides a method of making a tamping tool comprising: providing a paddle having a first face, a second face, a tip, and a first shoulder disposed in the first face, and defining a recess leading to the tip of the paddle; providing in the recess a first wear tile having an upper portion terminating in an upper edge, a lower portion that defines a ridge, and a face extending between the upper edge and the ridge, such that the upper edge of the first wear tile at least partially abuts the first shoulder, the ridge defined in the first wear tile at partially abuts the tip of the paddle, and the lower portion of the wear tile wraps substantially around the tip; and brazing the first wear tile to the paddle in multiple planes.

### BRIEF DESCRIPTION OF DRAWINGS

Various examples of embodiments of the systems, devices, and methods according to this invention will be described in detail, with reference to the following figures, wherein:

FIG. 1 illustrates an isometric view of a tamping tool, according to various examples of embodiments.

FIG. 2 illustrates a first face view of the tamping tool of FIG. 1 without wear tiles, according to various examples of embodiments.

FIG. 3 illustrates a first face view of the ballast tamping tool of FIG. 1, according to various examples of embodiments.

FIG. 4 illustrates a second face view of the ballast tamping tool of FIG. 1, according to various examples of embodiments.

FIG. 5 illustrates a cross-sectional view of the shank of FIG. 1, according to various examples of embodiments.

FIG. 6 illustrates a cross-sectional view of the ballast tamping tool of FIG. 1, according to various examples of embodiments.

FIG. 7 illustrates a detailed cross-sectional view of a paddle of the ballast tamping tool of FIG. 1, according to various examples of embodiments.

FIG. 8 illustrates an upper end view of the ballast tamping tool of FIG. 1, according to various examples of embodiments.

FIG. 9 illustrates a lower end view of the ballast tamping tool of FIG. 1, according to various examples of embodiments.

FIG. 10 illustrates a first face view of a ballast tamping tool without wear tiles, according to various examples of embodiments.

FIG. 11 illustrates a first cross-sectional view of the shank of FIG. 10, according to various examples of embodiments.

FIG. 12 illustrates a second cross-sectional view of the shank of FIG. 10, according to various examples of embodiments.

FIG. 13 illustrates a side view of the tamping tool of FIG. 10, according to various examples of embodiments.

FIG. 14 illustrates an isometric view of a first wear tile of the tamping tool of FIG. 1, according to various examples of embodiments.

FIG. 15 illustrates a face view of the first wear tile of FIG. 14, according to various examples of embodiments.

FIG. 16 illustrates a side view of the first wear tile of FIG. 14, according to various examples of embodiments.

FIG. 17 illustrates an isometric view of a first wear tile of the tamping tool of FIG. 1, according to various examples of embodiments.

FIG. 18 illustrates an isometric view of a first wear tile of the tamping tool of FIG. 1, according to various examples of embodiments.

FIG. 19 illustrates a face view of a second wear tile of the tamping tool of FIG. 1, according to various examples of embodiments.

FIG. 20 illustrates an edge view of the second wear tile of FIG. 19, according to various examples of embodiments.

FIG. 21 illustrates a side view of the second wear tile of FIG. 19, according to various examples of embodiments.

FIG. 22 illustrates a face view of a third wear tile of the tamping tool of FIG. 1, according to various examples of embodiments.

FIG. 23 illustrates an edge view of the third wear tile of FIG. 22, according to various examples of embodiments.

FIG. 24 illustrates a face view of a fourth wear tile of the tamping tool of FIG. 1, according to various examples of embodiments.

FIG. 25 illustrates an edge view of the fourth wear tile of FIG. 24, according to various examples of embodiments.

FIG. 26 illustrates a face view of a fifth wear tile of the tamping tool of FIG. 1, according to various examples of embodiments.

FIG. 27 illustrates an edge view of the fifth wear tile of FIG. 26, according to various examples of embodiments.

FIG. 28 illustrates a face view of a sixth wear tile of the tamping tool of FIG. 1, according to various examples of embodiments.

FIG. 29 illustrates an edge view of the sixth wear tile of FIG. 28, according to various examples of embodiments.

FIG. 30 illustrates a face view of a seventh wear tile of the tamping tool of FIG. 1, according to various examples of embodiments.

FIG. 31 illustrates an edge view of the seventh wear tile of FIG. 30, according to various examples of embodiments.

FIG. 32 illustrates a face view of an eighth wear tile of the tamping tool of FIG. 1, according to various examples of embodiments.

FIG. 33 illustrates an edge view of the eighth wear tile of FIG. 32, according to various examples of embodiments.

FIG. 34 illustrates a cross-sectional view of a lower portion of an exemplary embodiment of the tamping tool.

FIG. 35 illustrates a cross-sectional view of a lower portion of an exemplary embodiment of the tamping tool.

FIG. 36 illustrates a first face view of an exemplary embodiment of the tamping tool.

FIG. 37 illustrates a cross-sectional view of a lower portion of an exemplary embodiment of the tamping tool.

FIG. 38 illustrates a cross-sectional view of a lower portion of an exemplary embodiment of the tamping tool.

FIG. 39 illustrates a cross-sectional view of an exemplary embodiment of the tamping tool.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION OF EXEMPLARY EMBODIMENTS

Referring to the Figures, example embodiments of a tamping tool are provided.

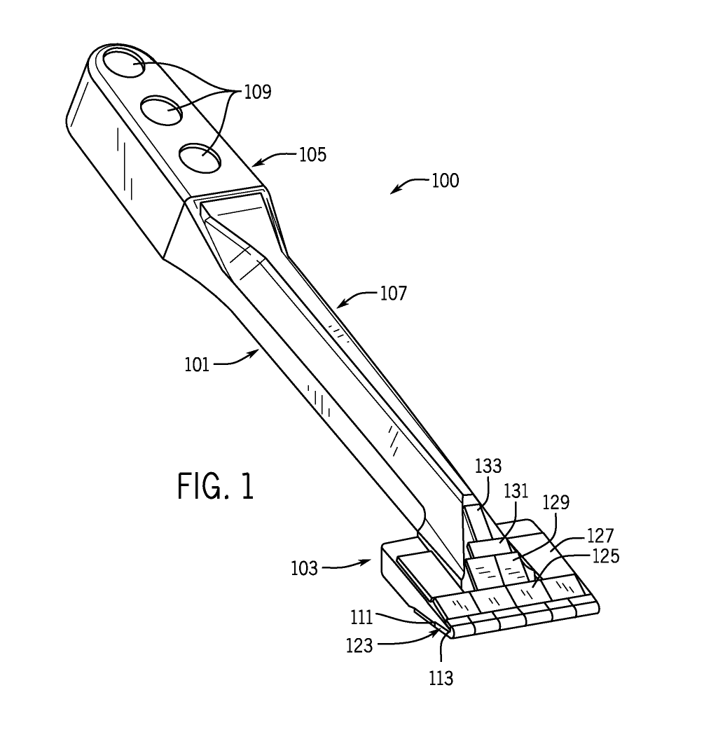

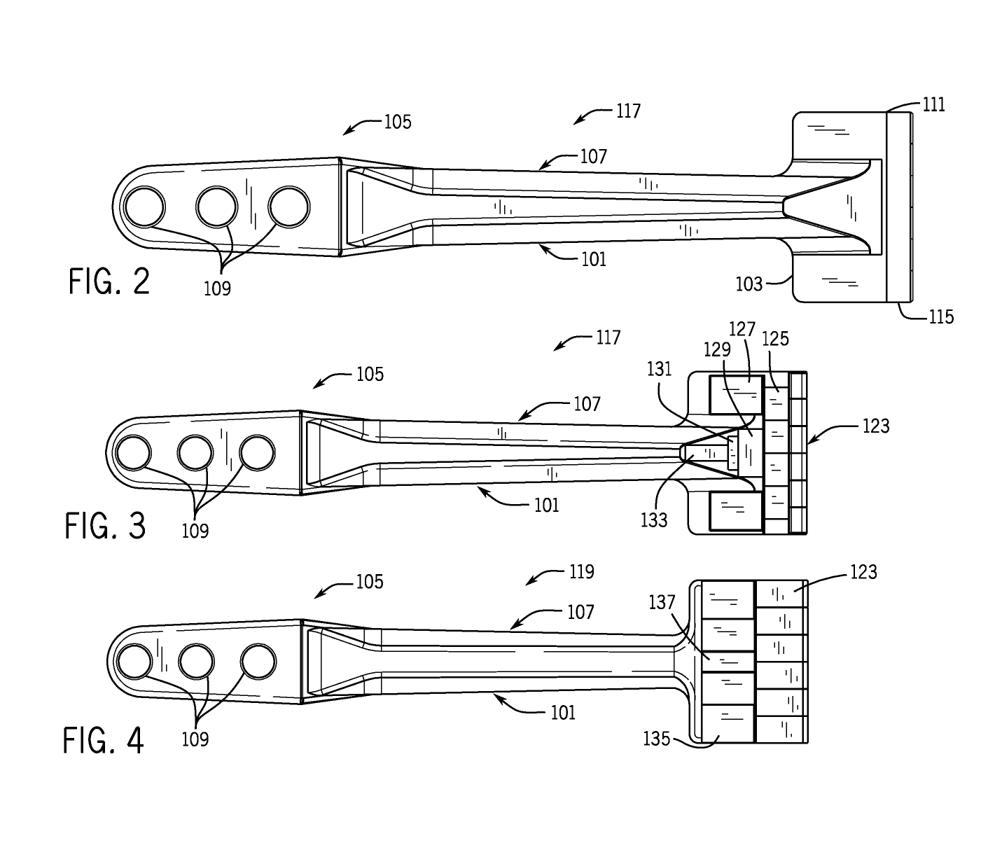

FIGS. 1-9 illustrate a first exemplary embodiment of a tamping tool 100, including a shank 101 having an upper portion 105 and a lower portion 107. Tamping tool 100 also includes a paddle 103.

As shown in FIGS. 1-9, paddle 103 and shank 101 are integrally formed. It should be appreciated, however, that in other embodiments the paddle and shank may be coupled in other ways including welding. In various embodiments, shank 101 includes four sides extending between upper portion 105 and lower portion 107. Between upper portion 105 and lower portion 107, in various embodiments, shank 101 tapers or may be beveled between sides and/or from side to side. The shank and paddle may be formed of metal such as iron or steel, but may also be formed in whole or part of an alloy such as a carbon-based alloy. In various embodiments, shank 101 and/or paddle 103 are forged but may also be heat treated (e.g, to improve the hardness of the material).

As shown in FIG. 1, upper portion 105 of shank 101 defines three apertures 109 which may be utilized to help couple the tamping tool to a tamping machine. Additional or fewer apertures may be defined in similar or different locations in the shank. In various examples of embodiments including those disclosed in FIGS. 1-9, lower portion 107 angles toward and is coupled to paddle 103.

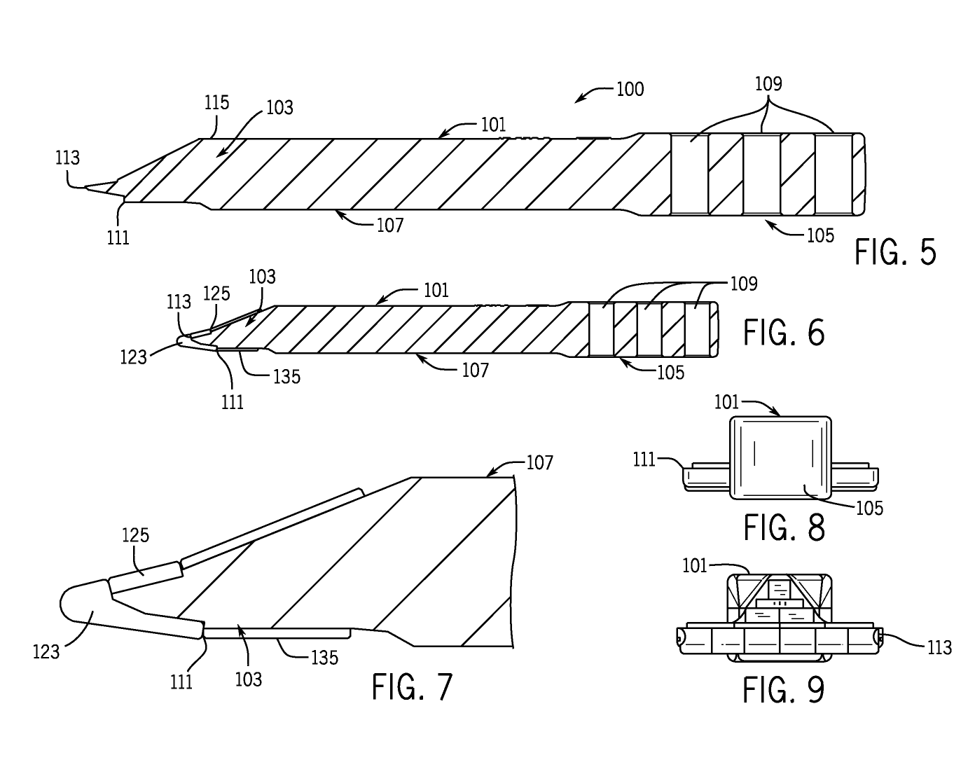

As further illustrated in FIGS. 1-9, and most specifically in FIGS. 5-7, in various embodiments, paddle 103 defines a first step, shoulder, wall or ridge 111 helping define a recess 123 extending between or leading to a tip or second shoulder 113 of the paddle 103.

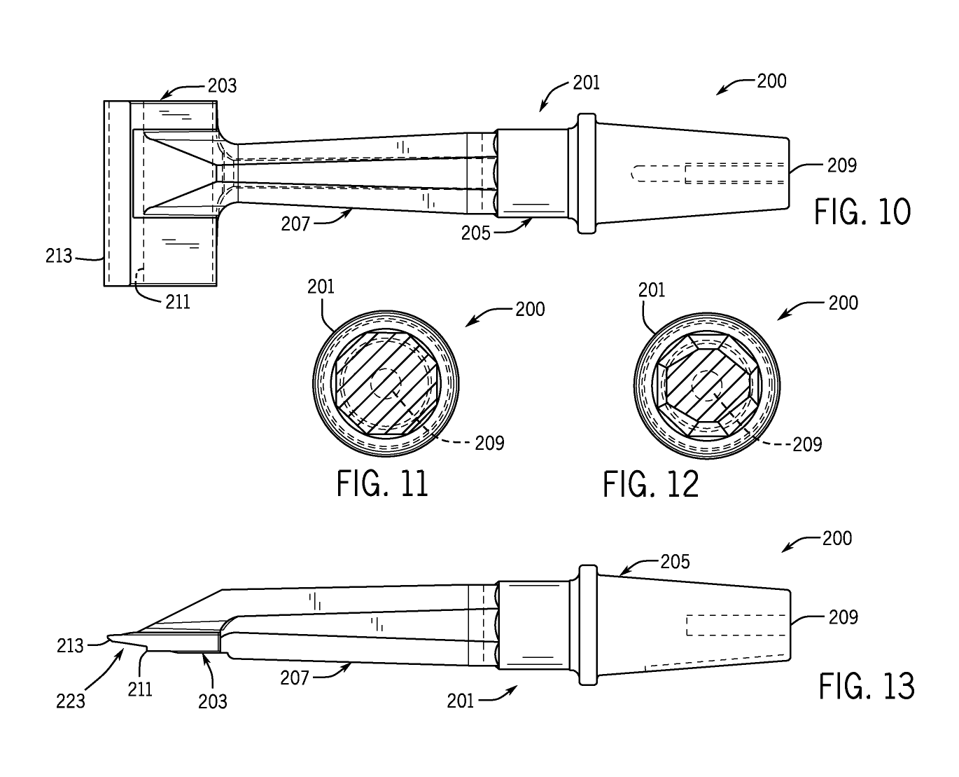

FIGS. 10-13 illustrate a second exemplary embodiment of a tamping tool 200, including a shank 201 having an upper portion 205 and a lower portion 207. Tamping tool 200 also includes a paddle 203.

As shown in FIGS. 10-13, paddle 203 and shank 201 are integrally formed. It should be appreciated, however, that in other embodiments the paddle and shank may be coupled in other ways including welding. The shank and paddle may be formed of metal such as iron or steel, but may also be formed in whole or part of an alloy such as a carbon-based alloy. In various embodiments, shank 201 and/or paddle 203 are forged but may also be heat treated (e.g, to improve the hardness of the material).

In various embodiments, upper portion 205 of shank 201 defines aperture 209 configured to attach or couple to a tamping machine, In various examples of embodiments, lower portion 207 angles toward and is coupled to paddle 203. As further illustrated in FIGS. 10-13, and most specifically in FIGS. 10 and 13, in various embodiments, paddle 203 defines a first step, shoulder, wall or ridge 211 helping define a recess 223 extending between or leading to a tip or second shoulder 213 of the paddle 103.

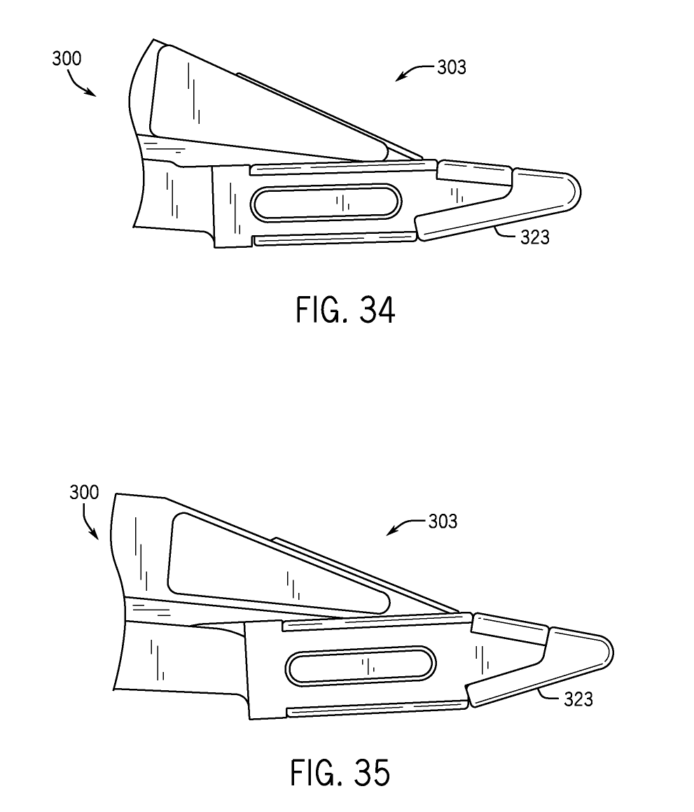

FIGS. 34-35 illustrate a third exemplary embodiment of a tamping tool 300, including a paddle 301 having a plurality of wear tiles including one or more first wear tiles 323.

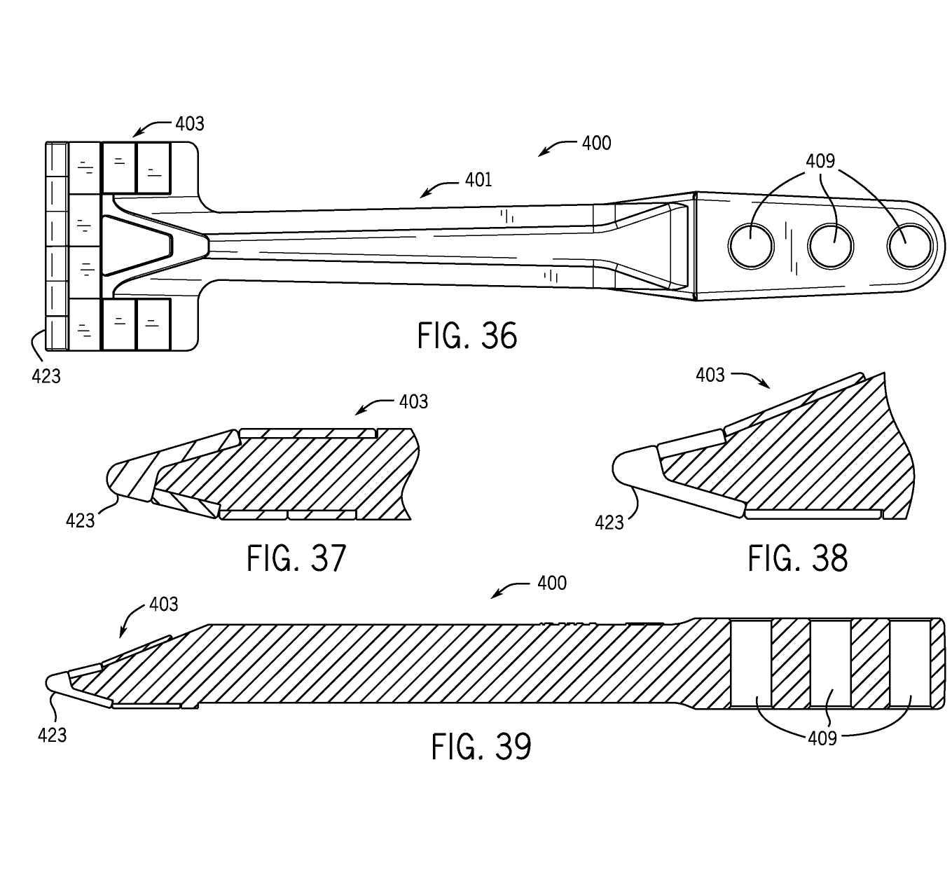

FIGS. 36-39 illustrate a fourth exemplary embodiment of a tamping tool 400, including a paddle 401 having a plurality of wear tiles including one or more first wear tiles 423 and a shank 403 having one or more apertures 409.

Referring again to FIGS. 1-9, in various embodiments, one or more first wear tiles 123, second wear tiles 125, third wear tiles 127, fourth wear tiles 129, fifth wear tiles 131, sixth wear tiles 133, seventh wear tiles 135, and/or eighth wear tiles 137 are provided on paddle 103 and/or lower portion 107 of shank 101.

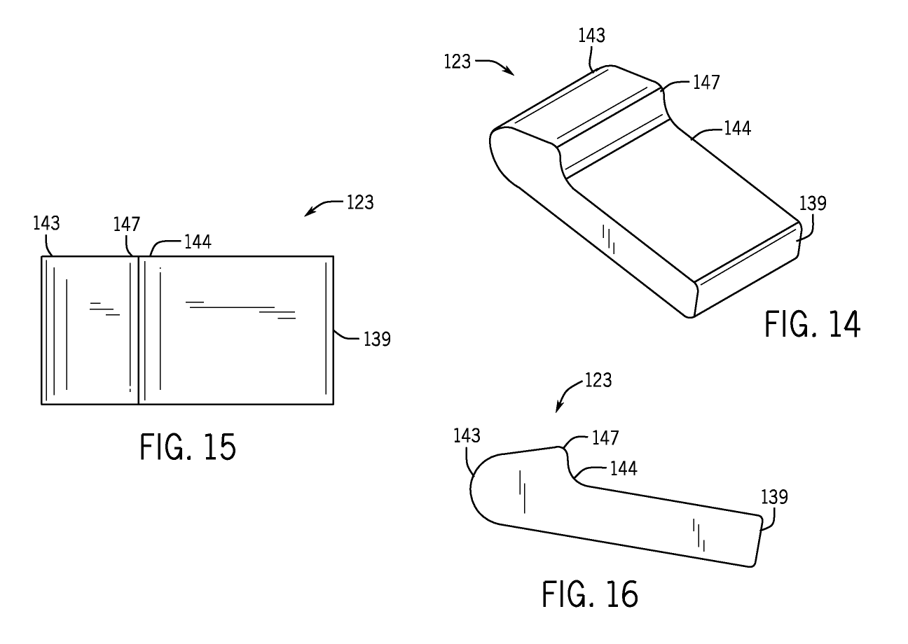

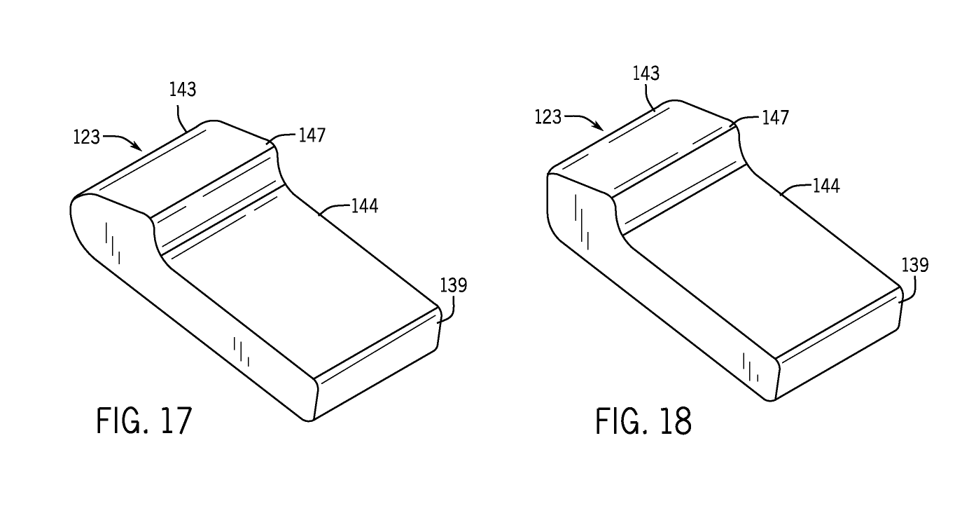

FIGS. 14-18 illustrate exemplary embodiments of first wear tile 123. Wear tile 123 includes a tip 143, a middle portion 144, and a lower edge 139. Tip 143 of first wear tile 123 can be rounded to a desire radius, or flattened with a slight curve (compare FIGS. 14 and 17 with FIG. 18). Between the middle portion 144 and tip 143, the tile defines a lip or ridge 147. The lip or ridge 147 may be beveled or rounded.

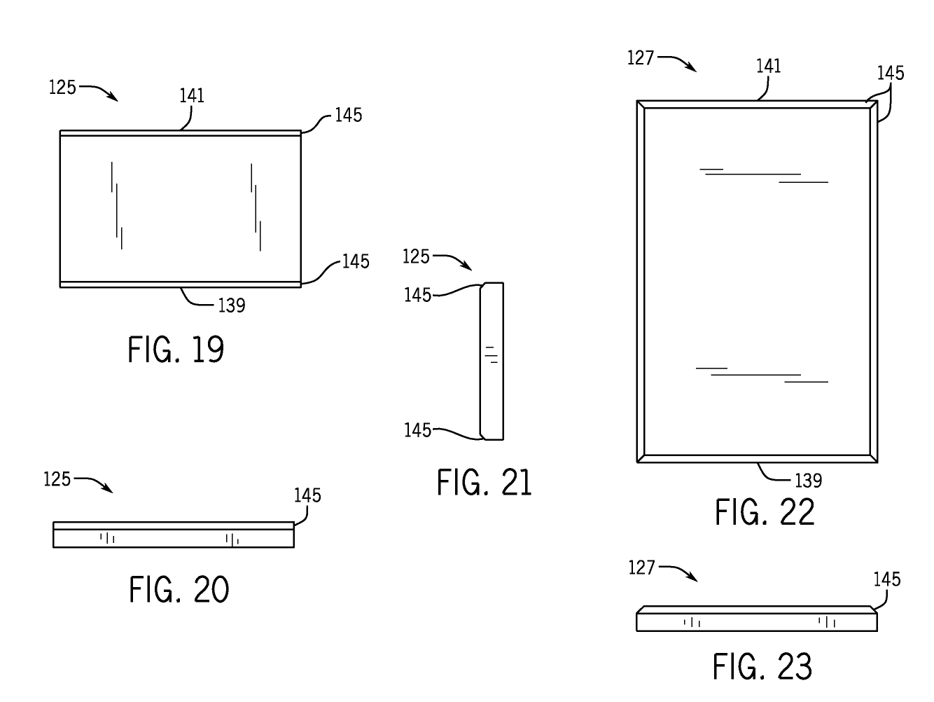

FIGS. 19-21 show three perspectives of an exemplary embodiment of a second wear tile 125. The wear tile is rectangular, with the long edges of the rectangle having an edge 145 that is angled or beveled on a first face of the tile. In an exemplary embodiment, the angle is approximately forty-five degrees.

FIGS. 22 and 23 show two perspectives of an exemplary embodiment of a third wear tile 127. All four edges 145 of the wear tile are angled or beveled on a first face of the tile. In an exemplary embodiment, the height of tile 127 is greater than its width.

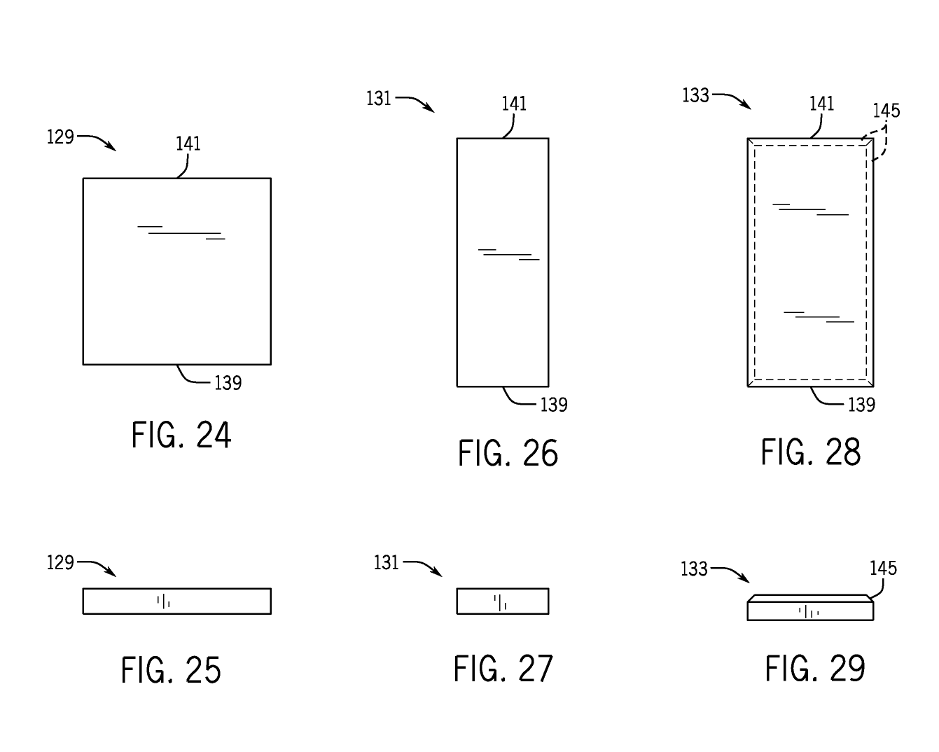

FIGS. 24 and 25 show an exemplary embodiment of a fourth wear tile 129. The exemplary tile is approximately square, with no beveling or angling of the edges on any face of the tile. FIGS. 26 and 27 show an exemplary embodiment of a fifth wear tile 131. The exemplary tile is rectangular, with the height longer than the width of the tile. None of the edges are beveled or angled.

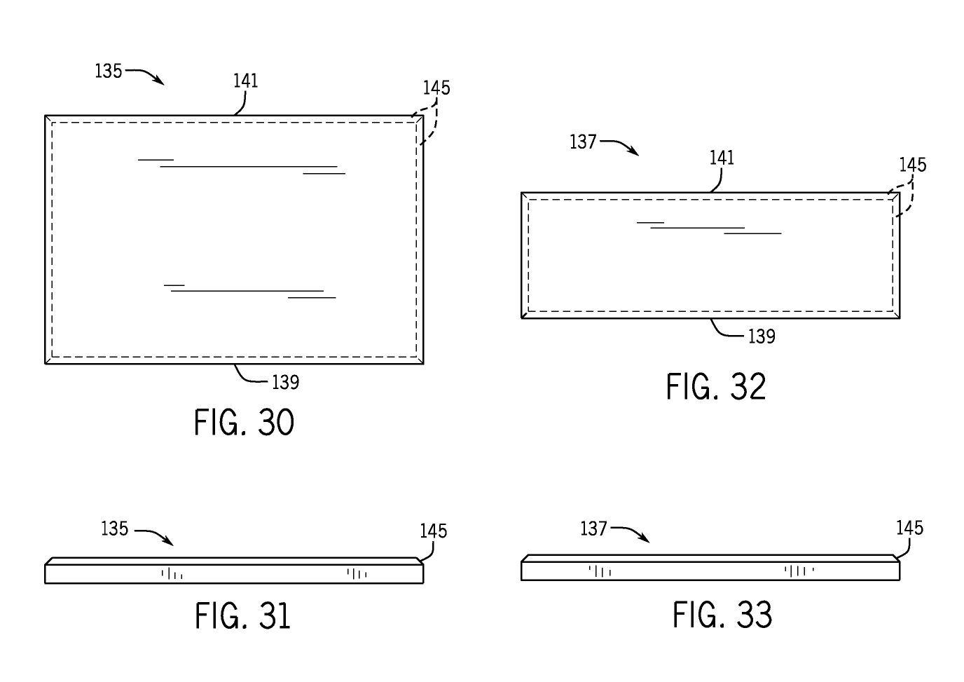

FIGS. 28 and 29 show an exemplary embodiment of a sixth wear tile 133. The exemplary tile is rectangular, with the height longer than the width. Each side 145 of a first face of tile 133 is beveled or angled. FIGS. 30 and 31 show an exemplary embodiment of a seventh wear tile 135. The exemplary tile is rectangular, with the width greater in length than the height. Each side 145 of a first face of seventh wear tile 135 is beveled or angled. FIGS. 32 and 33 show an exemplary embodiment of an eighth wear tile 137. The exemplary tile is rectangular, with the height substantially shorter than the width. All four edges 145 of eighth wear tile 137 are angled or beveled.

FIGS. 1, 3, 4, 6, 7, and 9 illustrate how the wear tiles are provided on and/or in a tamping tool according to various embodiments.

As shown in these Figures, one or more first wear tiles 123 are at least partially provided in the recess 115 such that an upper edge 141 of first wear tile 123 abuts first step, shoulder, wall or ridge 111 and a lower edge 139 of first wear tile 123 abuts the tip or second shoulder 113. The abutment against the first and second shoulders helps to secure the first wear tile to the paddle. In various embodiments, first 111 and second 113 shoulders are designed and/or utilized to help transfer impact on first wear tiles 123 into the paddle 103 and/or shank 101 so more of the tool can help absorb the impact. The first step, shoulder, wall or ridge 111 and/or the tip or second shoulder 103 also allows the wear tiles 115 to be brazed to the paddle in one or more planes (e.g., horizontal, vertical and/or angular planes). Brazing it in various planes (e.g., at the first step, shoulder, wall or ridge) helps further secure or otherwise couple wear tile 123 to the tool and helps to transfer impact, stresses and forces on the wear tile to the paddle and/or shank.

An exemplary configuration of first wear tiles 123 is disclosed in detail in FIG. 9 and in greater detail in FIG. 7. The upper edge 141 of the first wear tile 123 may overlap or extend beyond first shoulder or ridge 111. Lower edge 139 of first wear tile 123 may overlap or extend beyond second shoulder or ridge 113. In such embodiments, to help further secure first wear tiles 123 to the paddle and to otherwise help protect the paddle from abrasion or wear, one or more second wear tiles 125 may be coupled to the paddle 103. For example, as illustrated in FIG. 7, one or more second wear tiles 125 having a lower edge 139 and upper edge 141 are provided on a first face or front 117 of the paddle, the lower edges of which abut a section of the middle portion 144 of first wear tile 115 which overlaps or extends beyond tip or second shoulder 113. First wear tile 123 then wraps around the tip of the tamping tool 100. The lower edge 139 of the first wear tile 123 abuts a portion of a lower edge 139 of seventh wear tiles 135 provided on a second face 119 of paddle 103.

As shown in an exemplary embodiment disclosed in FIGS. 1 and 3, one or more third wear tiles 127 having a lower edge 139 are provided on a first face of the paddle 117, the lower edges 139 of which abut an upper edge 141 of one or more second wear tiles 125. FIGS. 22-23 illustrate an exemplary embodiment of the shape of the second wear tiles 127.

FIGS. 1 and 3 next disclose one or more fourth wear tiles 129 having a lower edge 139 and an upper edge 141 provided on lower portion 107 of the shank 101 coupled to a first face 117 of the paddle 103; lower edge 139 abuts an upper edge of one or more second tiles 125. FIGS. 1 and 3 also illustrate a fifth wear tile 133 provided on the first face 117 of the paddle 103 having a lower edge 139 and an upper edge 141 provided on the lower portion 107 of shank 101, such that lower edge 139 abuts upper edge 141 of one or more fourth tiles 129. As shown in FIGS. 1 and 3, one or more sixth wear tiles 133 are provided on lower portion 107 of shank 101, such that lower edge 139 of one or more sixth wear tiles 133 abuts upper edge 141 of one or more fifth wear tiles 131.

In various embodiments, including that shown in FIG. 4, one or more seventh wear tiles 135 having a lower edge 139 are provided on second face 119 of paddle 103, with lower edge 139 abutting a portion of first wear tile 123 which overlaps, projects or extends beyond the first shoulder, wall or ridge 111. In various embodiments, one or more eighth wear tiles 137 having a lower edge 139 are provided on second face 119 of paddle 103 beside or between one or more seventh wear tiles 135. The lower edges 139 of one or more eighth wear tiles 137 also abut a portion of first wear tile 123.

FIGS. 34 and 35 provide another exemplary disclosure of a first wear tile 323 in another embodiment of the tamping tool 300. Included on the paddle 303 is at least one first wear tile 323. In various embodiments, the exemplary tool has the remaining wear tiles (such as the second, third, fourth, fifth, sixth, seventh, and eighth wear tiles) embedded into a paddle 303. In an exemplary embodiment, the wear tiles are provided in recesses and/or abut against one or more shoulders of paddle 303.

FIGS. 37 and 38 provide further exemplary disclosures of configurations of wear tiles on the top portion of the tamping tool 400. Included on the paddle 403 is at least one first wear tile 423 provided within one or more shoulders or recesses. In various embodiments, the exemplary tool has the remaining wear tiles (such as the second, third, fourth, fifth, sixth, seventh, and eighth wear tiles) provided on a paddle 403. In an exemplary embodiment, some or all of the remaining wear tiles are provided in recesses and/or abut against one or more shoulders of or defined by paddle 403.

In an exemplary embodiment, the wear tiles are made of a wear or abrasion resistant material such as tungsten carbide. It should be recognized that one skilled in the art could substitute a variety of metals in particular mixtures to achieve the invention disclosed. The wear tile and/or tiles may be provided on and/or coupled to the paddle and/or shank in a variety of ways. For example, the tiles and/or wear tiles may be coupled to the paddle and/or shank by brazing, soldering, gluing, etc. While a silver braze or filler metal is utilized to couple the tile and wear tiles to the paddle and/or shank, it should be appreciated that a variety of brazes or filler metals may be utilized including a silver-brass filler metal.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “front” and “back” and “upper” and “lower”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the apparatus, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

What is claimed is:

1. A tamping tool comprising:
a shank having an upper and lower portion, the upper portion having a plurality of apertures and the lower portion being coupled to a paddle;
the paddle comprising:
a first face, a second face, and a tip;
a first shoulder disposed in the first face and defining a recess leading to the tip of the paddle;
a plurality of first wear tiles each having an upper portion terminating in an upper edge and a lower portion that defines a ridge and which tapers into a rounded tip;
the plurality of first wear tiles being at least partially provided in the recess such that the upper edge of each first wear tile at least partially abuts the first shoulder, the ridge defined in each first wear tile at partially abuts the tip of the paddle, and the lower portion of each first wear tile wraps substantially around the tip.

2. The tamping tool of claim 1 wherein a plurality of second wear tiles is provided on the first face and the second face of the paddle.

3. The tamping tool of claim 2, wherein the plurality of second wear tiles abuts a portion of the upper edges of the first wear tiles or a portion of the ridge defined in each first wear tile.

4. The tamping tool of claim 3 wherein a plurality of third wear tiles extends onto the lower portion of the shank where the paddle joins the shaft.

5. The tamping tool of claim 4 wherein the plurality of first, second and third wear tiles is made of an abrasion-resistant material.

6. The tamping tool of claim 5 wherein the abrasion resistant material is tungsten carbide.

7. The tamping tool of claim 1 wherein one or more of the plurality of first wear tiles provided within the recess is brazed to the paddle in multiple planes.

8. A tamping tool, comprising a shank and a paddle:
the shank having an upper and lower portion, the upper portion being configured to couple to a tamping machine and the lower portion being coupled to the paddle;
a plurality of wear tiles coupled to the lower portion of the shank;
the paddle having a first face, second face, and tip;
the first and second face having a plurality of wear tiles provided thereon;
the first face having a ridge;
the plurality of wear tiles including a plurality of first wear tiles, each having an upper portion terminating in an upper edge and a lower portion that defines a ridge and which tapers into a rounded tip;
the plurality of first wear tiles configured such that the first wear tiles abut the ridge provided on the paddle and extend around the paddle tip.

9. The tamping tool of claim 7 wherein one or more of the wear tiles are brazed to the paddle in one or more planes.

10. The tamping tool of claim 7 wherein the shank or paddle is forged.

11. The tamping tool of claim 7 wherein the shank or paddle is comprised of a group consisting of iron, steel, or an alloy such as a carbon-based alloy

12. The tamping tool of claim 7 where the wear tiles are comprised of tungsten carbide.

13. A method of making a tamping tool comprising:
providing a paddle having a first face, a second face, a tip, and a first shoulder disposed in the first face, and defining a recess leading to the tip of the paddle;
providing in the recess a first wear tile having an upper portion terminating in an upper edge, a lower portion that defines a ridge, and a face extending between the upper edge and the ridge, such that the upper edge of the first wear tile at least partially abuts the first shoulder, the ridge defined in the first wear tile at partially abuts the tip of the paddle, and the lower portion of the wear tile wraps substantially around the tip; and
brazing the first wear tile to the paddle in multiple planes.

14. The method of claim 13, further comprising brazing the upper edge of the first wear tile to the first shoulder; brazing the ridge defined in the first wear tile to the tip of the paddle; and brazing the face extending between the upper edge and the ridge to the recess leading to the tip of the paddle.

15. The method of claim 13, further comprising providing a second wear tile on the first face of the paddle.

16. The method of claim 14, wherein the second wear tile is provided such that it abuts a portion of the upper edge of the first wear tile.

17. The method of claim 13, further comprising providing a second wear tile on the second face of the paddle.

18. The method of claim 16, wherein the second wear tile is provided such that it abuts a portion of the ridge defined in each first wear tile.
